(19) United States
(12) Patent Application Publication
(10) Pub. No.: US 2004/0239038 A1
(43) Pub. Date: Dec. 2, 2004

(54) Method for the production of a closure of a hollow area in a glass tube

(76) Inventors: Ralf Kramp, Reutlingen (DE); Ingo Gorille, Oberriexingen (DE)

Correspondence Address: Striker Striker & Stenby, 103 East Neck Road, Huntington, NY, 11743, US

(21) Appl. No.: 10/486,640

(22) PCT Filed: Aug. 13, 2002
(86) PCT No.: PCT/DE02/02979

(30) Foreign Application Priority Data
Aug. 13, 2001 (DE) 101386281

(51) Int. Cl. E04B 1/682

(52) U.S. Cl. 277/316

(57) ABSTRACT

In the method for producing a seal of a hollow chamber (12) of a glass tube (10), wherein the hollow chamber (12) contains fillers at a pressure greater than that of the atmosphere, the glass tube (10) is disposed in a working chamber (30) in which a pressure is generated that is greater than the pressure prevailing in the hollow chamber (12). The working chamber (30) contains a heating unit (50), which encompasses the glass tube (10) in a section (16) adjoining the hollow chamber (12) on at least one end and which melts the section (16) so that when melted, it is squeezed together by the pressure prevailing in the working chamber (30), thus sealing the hollow chamber (12) on at least one end. The glass tube (10) preferably constitutes a burner of a discharge lamp, in particular for use in motor vehicle headlights.

### PRIOR ART

The invention is based on a method for producing a seal of a hollow chamber in a glass tube as generically defined by the preamble to claim 1.

A method of this kind is used, for example, in the production of a glass tube that serves as a burner of a discharge lamp. The hollow space contains fillers, among others at least one gaseous filler, at a pressure greater than that of the atmosphere. In order to seal the hollow chamber, with the gaseous filler in the hollow chamber at the required pressure, the glass body is surrounded with liquid nitrogen at the already-closed end of the hollow chamber in order to intensely cool the gaseous filler so that it transitions into the solid state and only a low pressure or a vacuum prevails in the hollow chamber. At the end of the hollow chamber that is not yet closed, the glass tube is then heated with a hydrogen flame until the glass melts and is squeezed together by the higher surrounding pressure and by metal jaws. This method is very expensive and difficult to control since the glass tube must be melted a short time after being nitrogen cooled and the squeezing must occur very quickly since the heating causes the pressure of the gaseous filler to increase again. Also, the use of a hydrogen flame requires the observance of extensive safety precautions.

### ADVANTAGES OF THE INVENTION

The method according to the invention, with the characterizing features of claim 1, has the advantage over the prior art that it is easier to execute since it does not require cooling of the gaseous filler and since producing the seal of the hollow chamber requires only the melting of the glass tube by means of the heating unit; the pressure differential between the working chamber and the hollow chamber of the glass tube, which can be arbitrarily set, squeezes the tube together at the point at which it has been melted.

Advantageous embodiments and modifications of the method according to the invention are disclosed in the dependent claims. The features according to claim 6 facilitate the production of the high pressure in the working chamber and also prevent damage to the glass tube and an oxidation of the heating unit. The features according to claim 7 make it possible to control the heating unit in a simple manner.

### DRAWING

An exemplary embodiment of the invention is shown in the drawing and will be explained in detail in the description that follows.

FIG. 1 is a schematic depiction of a device for executing the method according to the invention.

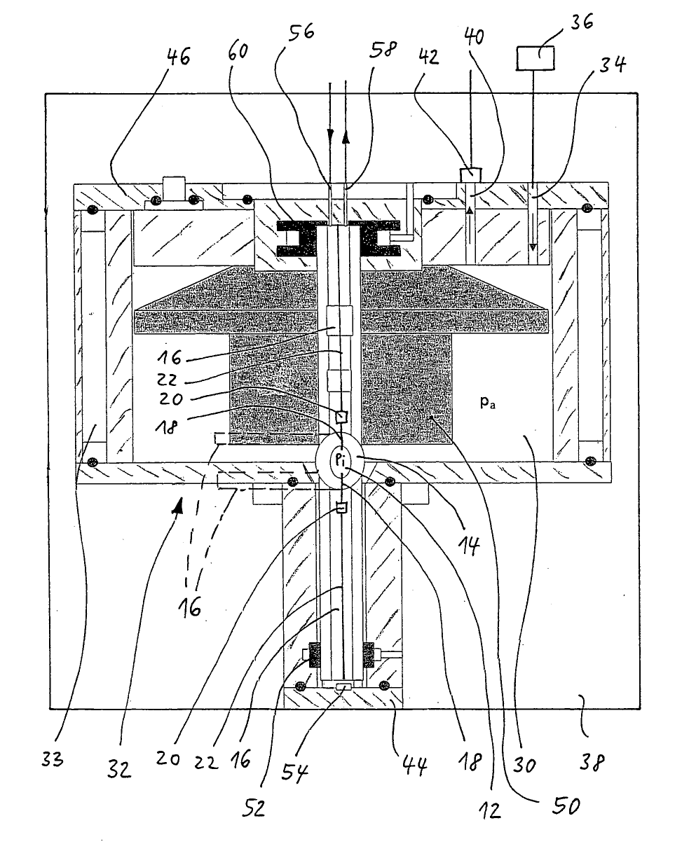

### DESCRIPTION OF THE EXEMPLARY EMBODIMENT

The sole figure shows a device for executing a method for producing a seal of a hollow chamber 12 of a glass tube 10. The glass tube 10 preferably constitutes a burner of a discharge lamp, which is in particular used as a light source in illumination devices of motor vehicles. The glass tube 10 is comprised of quartz glass and has an enlarged region 14 approximately in its center region, viewed in the direction of its longitudinal axis, in which the hollow chamber 12 is formed. The enlarged region 14 is adjoined at both ends by tubular sections 16 with a smaller cross section than the enlarged region 14. The tubular sections 16 each contain an electrode 18, which protrudes with its one end into the hollow chamber 12 and at its other end, is connected to a metal foil 20 that is disposed in each of the tubular sections 16. The electrodes 18 are comprised, for example, of tungsten or a tungsten alloy and the metal foils 20 are comprised, for example, of molybdenum or a molybdenum alloy. Electrical lines 22 are connected to the metal foils 20 and extend in the tubular sections 16. The lines 22 are comprised, for example, of molybdenum or a molybdenum alloy.

The hollow chamber 12 contains various fillers, among others mercury. Other fillers it contains include iodides, i.e. metal halides. It also contains a gaseous filler, preferably an inert gas. Preferably xenon is used as the inert gas, but argon or krypton can also be used. The xenon is contained in the hollow chamber 12 at a pressure of approximately 7 bar at room temperature and is used, when igniting and starting up the discharge lamp, to assure a reliable production of light. After the discharge lamp has started, the light is produced essentially by the mercury; the color of light can be influenced by means of the iodides.

When the burner is manufactured, first the glass tube 10 is preformed out of quartz glass, with the enlarged region 14 and the tubular sections 16. The electrodes 18, the foils 20, and the lines 22 are introduced through the tubular sections 16. Then the required quantities of solid or fluid fillers, i.e. the mercury and the iodides, are introduced into the hollow chamber 12. Then the gaseous filler in the form of the xenon must be introduced into the hollow chamber 12 at the required pressure pi and the hollow chamber 12 must be sealed. The device and method for this will be explained in detail below.

In order to introduce the gaseous filler and produce the seal of the hollow chamber 12 of the glass tube 10, the glass tube 10 is inserted into a working chamber 30 in which a pressure pa is generated that is higher than the pressure pi prevailing in the hollow chamber 12. The pressure pa in the working chamber 30 is set so that it is at least 1 bar higher than the pressure pi prevailing in the hollow chamber 12. Preferably, the pressure pa in the working chamber 30 is set so that it is significantly higher than the pressure pi in the hollow chamber 12. The difference between the pressure pa in the working chamber 30 and the pressure pi in the hollow chamber 12 is selected as a function of the material of the glass tube 10 and as a function of the required properties of the finished burner. It is also possible for the pressure pa in the working chamber 30 to be variably adjusted during the filling of the hollow chamber 12 with the gaseous filler and during the production of the seal of the hollow chamber 12.

The working chamber 30 is delimited by a housing 32 that is embodied approximately in the form of a cup and has a fluid-filled casing 33 for cooling purposes. The working chamber 30 is preferably supplied with an inert gas, for example helium, as a filler, thus generating the increased pressure pa in the working chamber 30. To this end, the housing 32 has at least one opening 34, through which the inert gas is supplied from the outside, for example by means of a pump or from a pressurized tank 36. The housing 32 is preferably disposed inside an additional sealed chamber 38, which is likewise filled with inert gas, for example argon, but in which a lower pressure prevails than in the working chamber 30. Filling the chamber 38 with inert gas protects the fillers of the hollow chamber 12 from reacting with oxygen. The housing 32 can also have at least one outlet opening 40, which is controlled, for example, by means of a valve 42 that can limit the pressure pa prevailing in the working chamber 30. The housing 32 can have a separate bottom 44 and cover 46, which are snugly attached to the rest of the housing 32, but which can be detached from the housing 32 for insertion of the glass tube 10 into the working chamber 30 and for removal of same.

The working chamber 30 contains a heating unit 50 that is preferably an electric heating unit. Alternatively, a plasma burner can also be used as the heating unit. The heating unit 50 is operated with direct current and is designed to be low-impedance. The heating unit 50 is comprised, for example, of graphite, tantalum, molybdenum, osmium, rhenium, or tungsten, or of a mixture of several of these materials. The heating unit 50 is embodied at least approximately in the shape of a hollow cylinder so that when a glass tube 10 is disposed in the working chamber 30, the heating unit 50 encompasses at least one of the tubular sections 16.

If the glass tube 10 with the hollow chamber 12 is disposed unsealed in the working chamber 30, then at one end of the hollow chamber 12, the tubular section 16 can be closed without filling the hollow chamber 12 with the xenon. The hollow chamber 12 can thus be connected to the chamber 38 so that the same pressure prevails in it as in the chamber 38. Close to the end of the tubular section 16 of the glass tube 10 oriented away from the hollow chamber 12, a seal 52 that seals the working chamber 30 is provided between the section 16 and the bottom 44 of the housing 32. In order to seal the tubular section 16 of the glass tube 10, the heating unit 50 is supplied with voltage. The electrical power is transmitted to the section 16 by means of radiation and also by means of heat conduction via the inert gas contained in the working chamber 30. As a result, the tubular section 16 of the glass tube 10 is heated so intensely that the glass melts. The pressure pa prevailing in the working chamber 30 squeezes the melted tubular section 16 together so that in particular, the metal foil 20, but also parts of the electrode 18 and the line 22 are enclosed by the glass and the hollow chamber 12 is sealed shut. Then the glass tube 10 is cooled so that the glass in the region of the tubular section 16 hardens again.

Preferably, a sensor unit 54 detects the state of the tubular section 16 of the glass tube 10 during the heating. The sensor unit 54 can be a photosensor unit that is disposed at the end of the tubular section 16. During the heating of the section 16, the photosensor unit 54 detects its light intensity, which is proportional to the temperature of the section 16 and therefore can be used as an indirect measure of the temperature of the quartz glass of the section 16. A calibration of the photosensor unit 54 with regard to characteristic values of the glass temperature of the section 16 can be executed during a trial operation based on practical results. The signal generated by the sensor unit 54 is used to control the heating unit 50, thus making it possible to execute the heating of the section 16 optimally by appropriately controlling the heating capacity of the heating unit 50. The heating capacity of the heating unit 50 is also a function of the thickness of the tubular section 16, i.e. the mass of glass to be heated and melted.

The pressure pa in the working chamber 30 is set to a predetermined value by supplying an appropriate amount of inert gas through the opening 34. If the pressure pa increases during operation of the heating unit 50, then this can be limited by allowing gas to escape from the working chamber 30 through the outlet opening 40, possibly controlled by the valve 42.

If the tubular section 16 of the glass tube 10 has been sealed shut at one end of the hollow chamber 12 as described above, then the tubular section 16 at the other end of the hollow chamber 12 is subsequently also sealed shut. The cover 46 has at least one first opening 56 through which the hollow chamber 12 is supplied with the inert gas, preferably xenon, at the required pressure. The cover 46 of the housing 32 also has at least one second opening 58 through which the hollow chamber 12 is evacuated by means of a vacuum pump. The evacuation of the hollow chamber 12 serves to prevent the xenon gas from mixing with other components in the hollow chamber 12. Between the cover 46 and the tubular section 16 of the glass tube 10, close to its end oriented away from the hollow chamber 12, a seal 60 is provided, which seals the working chamber 30. While the pressure pi required for the xenon is maintained in the hollow chamber 12, the heating unit 50 is activated so that the glass in the tubular section 16 melts and is squeezed together by the pressure pa in the working chamber 30, which is considerably higher than the pressure pi prevailing in the hollow chamber 12. Then the glass tube 10 is cooled so that the glass hardens again and the electrode 18, the metal foil 20, and the line 22 in the section 16 are encapsulated and the hollow chamber 12 is sealed shut. The same sensor unit 54 used in the other tubular section 16 of the glass tube 10 or a separate sensor unit can be used to control the heating unit 50. Preferably, when producing the seal of the two tubular sections 16 of the glass tube 10, at least approximately the same pressure differential is set between the working chamber 30 and the hollow chamber 12 in order to obtain the same results for both sections 16.

The introduction of fillers into the hollow chamber 12 occurs in the chamber 38 and the production of the seal of the hollow chamber 12 occurs in the working chamber 30, which is disposed inside the additional chamber 38. The pressure pa in the working chamber 30 and the heating capacity of the heating unit 50 can be controlled in a simple manner that allows a reliable seal of the hollow chamber 12 to be produced. The quartz glass of which the glass tube 10 is comprised is heated to glowing in a vacuum for a relatively long period in order to rid it of H2 and OH groups before it is used to produce the glass tube 10. The glass tube 10 remains in this state during the above-described processing in the working chamber 30 because it no longer comes into contact with H2 or OH groups. It is also very easy to use other fillers in the hollow chamber 12, i.e. argon can also be used as the inert gas instead of xenon, without having to change the method.

It is also possible for the sealing of the hollow chamber 12 at the tubular sections 16 to occur at both ends simultaneously, using a shared heating unit 50 or using separate heating units 50. Instead of being disposed approximately coaxial to each other at opposite ends of the hollow chamber 12 as depicted with solid lines in the figure, it can be advantageous for the tubular sections 16 of the glass tube 10 to be disposed at the same end of the hollow chamber 12, as depicted with dashed lines in the figure.

1. A method for producing a seal of a hollow chamber (12) of a glass tube (10), wherein the hollow chamber (12) contains fillers at a pressure greater than that of the atmosphere, characterized in that the glass tube (10) is disposed in a working chamber (30) in which a pressure is generated that is greater than the pressure prevailing in the hollow chamber (12) and in that the working chamber (30) contains a heating unit (50), which encompasses the glass tube (10) in a section (16) adjoining the hollow chamber (12) on at least one end and which melts the section (16) so that when melted, it is squeezed together by the pressure prevailing in the working chamber (30), thus sealing the hollow chamber (12) on at least one end.

2. The method according to claim 1, characterized in that during the production of the seal, the hollow chamber (12) is supplied with a gaseous filler at the required pressure from outside the working chamber (30).

3. The method according to claim 2, characterized in that an inert gas is used as the gaseous filler, preferably xenon, argon, or krypton at a pressure of at least approximately 7 bar.

4. The method according to one of claims 1 to 3, characterized in that the heating unit (50) is an electric heating unit.

5. The method according to claim 4, characterized in that the heating unit (50) is comprised alternatively of graphite, tantalum, molybdenum, osmium, rhenium, or tungsten, or of a mixture of these materials.

6. The method according to one of the preceding claims, characterized in that the working chamber (30) is supplied with an inert gas, preferably helium.

7. The method according to one of the preceding claims, characterized in that a sensor unit (54) is provided that detects the state of the glass tube (10) in the region (16) to be melted and generates a signal, which is proportional to the temperature of this region (16) and is used to control the heating capacity of the heating unit (50).

8. The method according to one of the preceding claims, characterized in that the heating capacity of the heating unit (50) is controlled as a function of the wall thickness of the region (16) of the glass tube (10) to be melted.

9. The method according to one of the preceding claims, characterized in that the pressure prevailing in the working chamber (30) and/or the heating capacity of the heating unit (50) is/are variably controlled during the production of the seal of the hollow chamber (12).

10. The method according to one of the preceding claims, characterized in that the working chamber (30) is delimited in a housing (32) that is disposed in a chamber (38) that is filled with an inert gas, preferably argon.

11. The method according to one of the preceding claims, characterized in that the glass tube (10) constitutes a burner of a discharge lamp, in particular for use in motor vehicle headlights.

12. The method according to claim 11, characterized in that the hollow chamber (12) contains mercury and iodides as fillers.
